(19) United States
(12) Patent Application Publication
(10) Pub. No.: US 2012/0031998 A1
(43) Pub. Date: Feb. 9, 2012

(54) FLUSHING SYSTEM

(76) Inventor: Thomas Jinbäck, Eslov (SE)

(21) Appl. No.: 13/259,545

(22) PCT Filed: Apr. 1, 2010
(86) PCT No.: PCT/SE2010/050370

§ 371 Date: Sep. 23, 2011

(30) Foreign Application Priority Data
Apr. 8, 2009 (SE) 0900469-8

(51) Int. Cl. B05B 15/06

(52) U.S. Cl. 239/289

(57) ABSTRACT

An anti-pirate system to prevent boarding of a vessel includes a number of spray devices (2) each with at least one nozzle (3) configured, upon activation, to spray out a liquid (4) which is supplied to the respective spray device (2) via a liquid-bearing arrangement. The spray devices (2) are configured to be disposed along at least one side (5) of the vessel and to be so disposed on the vessel that the respective nozzles of the spray device (2) are disposed in a position situated outside the vessel's side (5) or rail (6), so that spraying of liquid (4) out from each nozzle (3) results in the liquid (4) being sprayed from it in a direction which substantially follows the vessel's side (5).

### FIELD OF THE INVENTION

The present invention relates to an anti-piracy system to prevent boarding of a vessel.

### BACKGROUND TO THE INVENTION

Piracy has for several hundred years been a problem for shipping. In modem times, pirates use modern facilities such as fast motorboats, satellite telephones, GPS systems, actual weapons etc. to board and take over vessels. To protect vessels or to make it difficult for pirates to board them, certain vessels have had their rails equipped with electrically conductive elements and devices, e.g. electric barriers. These electrical elements and devices are intended to deliver an electric shock to a pirate trying to climb on board over the rail. These systems are reasonably effective. A problem with such electrical systems is that the vessel's crew may also be affected by them, which may happen inadvertently when crew members are on deck or close to the system or for any other reason inadvertently come into contact with the system. There are also other systems whereby one or more lines are dropped into the water behind the vessel and along its sides, the intention being that these lines should become entangled in the assailants' engine and thereby abort their attack on the vessel. However, this is a rather unsafe method in that it involves the crew having to detect the assailants at an early stage when the latter are still in their craft if any advantage is to be expected from then dropping the lines into the water. A further problem with dropping lines into the water is that quite a large degree of care has to be taken to ensure that the lines do not instead become entangled in the vessel's own propellers, which might result in disastrous damage to the vessel itself.

### SUMMARY OF THE INVENTION

An object of the present invention is to propose a system with spray devices which can flush elements away from the side of a vessel.

A further object of the invention is to propose a deterrent system which reduces the risk of a vessel being attacked by hostile persons such as pirates and being boarded.

A further object of the invention is to overcome the abovementioned problems of the state of the art.

A further object of the invention is to propose a device and a method which are cost-effective as compared with prior art, which device is easy to construct, making it possible to optimise both cost and time.

The aforesaid and other objects are achieved according to the invention by providing the system described in the introduction with the features indicated in claim 1.

Advantages achieved with a system according to claim 1 are that it can effectively prevent and deter an assailant from boarding a vessel, while at the same time it involves no risk to the health of the crew or risk of damage to the vessel.

Preferred embodiments of the device according to the invention are further provided with the features indicated by subclaims 2-14.

According to an embodiment of the invention, the spray devices are configured to be movable between a position in which the respective nozzles will be outside the vessel's side or rail and a position in which the respective nozzles will be within the vessel's side and rail. This means that when the vessel passes through restricted spaces, e.g. narrow channels, its hull being dimensioned to allow for the width of such passages, it will be necessary to be able to remove from the vessel's side any items which affect the vessel's width. The spray devices are therefore so configured as to make it possible to move them between the position in which they are outside the vessel's side and the position in which they are within the vessel's side.

According to a further embodiment of the invention, the liquid is sprayed out from the respective nozzles at high pressure, preferably exceeding 3 bar. This means that the liquid leaving each nozzle can thus be sprayed with sufficient force both to achieve sufficient reach and to be powerful enough to wash away from the vessel's side disturbing elements such as pirates.

According to a further embodiment of the invention, the liquid-bearing arrangement is configured to convey seawater to the spray devices with a view to seawater being sprayed from them. To this end, a pump device may be used to draw seawater from the sea and convey it to the spray devices. Alternatively, the liquid-bearing arrangement may be connected to an existing system of the vessel which has a pump device which draws in seawater.

According to a further embodiment of the invention, the water-bearing arrangement is configured to convey liquid from a liquid tank provided in the vessel to the respective spray devices for spraying of liquid. This means that liquid, e.g. water, may be stored in the vessel. Such a holding tank for water drawn from the sea may also be necessary if the seawater is polluted or contains particles. The particles or pollutants may then be separated from the water in the tank by a cleaning process, preventing them from entering the spray devices and from causing obstruction or failure of the system.

According to a further embodiment of the invention, the respective spray devices are so configured that each nozzle has an oscillating to and from movement in a plane parallel with the vessel's side so that liquid is sprayed out from the nozzle within an angle range of 0-180 degrees, in which 90 degrees represents a vertical direction from the nozzle towards the surface of the water in which the vessel floats. This means that the liquid leaving the nozzle flushes in the plane, creating a kind of liquid curtain substantially parallel with the vessel's side. During spraying of liquid, this plane will be outside and parallel with the vessel's side. This means that elements not belonging to the vessel, e.g. pirates, such as might be moving along or towards the vessel's side will be washed away by the liquid spraying out from the respective nozzles.

One or more spray devices may also be installed or positioned as necessary at the forward portion of the vessel, e.g. in the region of the bow, or at the rear of the vessel, e.g. in the region of the stern.

According to a further embodiment of the invention, each spray device is disposed on a respective frame with a regulating device, preferably a pressure cylinder, configured to move the spray device with the nozzle from the one position to the other. According to an embodiment, the spray device is so configured that the frame causes the spray device to tilt from the one position to the other. To this end, a pressure cylinder may be used to raise one side of the frame so that the spray device with the nozzle is angled over the rail to a position for spraying out liquid parallel with the vessel's side.

According to a further embodiment of the invention, each nozzle disposed in a position outside the vessel's side is caused to pass over the vessel's rail to that position from the position within the vessel's side. To this end, the spray device may be installed on the vessel's deck or rail.

According to a further embodiment of the invention, each nozzle disposed in a position outside the vessel's side is caused to pass out from an aperture in the side to that position from the position within the vessel's side. This means that when the spray device is not being used it is stored within the vessel. This may be necessary if the vessel's deck is such that it does not allow such devices to be installed. Another reason may be that certain vessels need to use the deck area as cargo space. A device installed on such a deck might therefore run great risk of being damaged by cargo and hence becoming unusable.

According to a further embodiment of the invention, upon activation of the respective spray devices the liquid in the liquid-bearing arrangement will be at a pressure which causes each spray device and nozzle to move from a position within the vessel's side to the position with the nozzle outside the vessel's side. To this end, the spray device may be so arranged that its regulating device is controlled by the pressure of the liquid in the liquid-bearing arrangement. This may be achieved by so configuring the system that when the liquid is pressurised, e.g. upon activation of the system, the regulating device will place the spray device in such a position that the nozzle is outside the vessel's side.

According to a further embodiment of the invention, each nozzle may be moved manually from the position within the vessel's side to the position outside the vessel's side. This makes it possible for the vessel's crew to place each nozzle in a position outside the vessel's side in order to spray out liquid.

According to a further embodiment of the invention, the system is configured to be activated by a control unit which controls the respective spray devices and the position of their nozzles. The system is configured to be activatable from a chosen position on the vessel, e.g. the vessel's navigating bridge, which is generally staffed when a vessel is in operation. When necessary, personnel may activate the system from their navigating bridge to start flushing so that disturbing elements are washed away from the vessel's sides. The system may also be configured to be activated from other locations on the vessel if there are other regions of the vessel from which it is preferred to activate the system.

According to a further embodiment of the invention, the control unit is remote-controlled, making it possible for the control unit to activate the system by electrical signals. A further embodiment is that the system may be activated by means of a wireless device. This may be desirable if the navigating bridge or the location on the vessel where the control unit is situated is unmanned, since the wireless device makes it possible for a crew member to merely carry a transmitter for activating the system as necessary.

According to a further embodiment of the invention, the system is configured to be activated from a navigating bridge on the vessel. This means that no crew members need be on deck to assist the positioning of the spray devices. On the navigating bridge it is therefore an advantage if the system can be activated by a person there merely pressing a button or similar activating device to start the system.

According to an embodiment, the vessel's sides are monitored via cameras so disposed that the vessel's sides can be viewed via them. The respective cameras are configured to record what happens along the vessel's sides and on the water surface around the vessel. Should the vessel's sides be subject to disturbing elements, e.g. hostile boarding by someone trying to climb up the vessel's sides and board the vessel, this will be recorded by the cameras. The cameras then send a signal to a unit which converts the signal so that what the camera has recorded can be seen on a video screen by a person who can then activate the system. Alternatively, the signals from the cameras may be sent to a person who need not necessarily be a member of the vessel's crew. That person may be at some other location, e.g. ashore in front of a video screen, and may continuously view and monitor the vessel's sides and the water near to the vessel. Should so-called disturbing or threatening elements approach the vessel as above, this may be observed on the screen by the person ashore, who may therefore send a signal from there to the vessel's control unit to activate the system. This may be of advantage in the case of a vessel with such a small number of crew members that they have little or no possibility of continuously monitoring the vessel's sides. A further alternative is for the vessel's sides to be provided with sensors configured to detect any disturbing elements on the respective sides. The sensors will then detect such disturbing elements and can send a signal to a supervisor or to the control unit to activate the system. A further alternative is for the cameras to cooperate with sensors situated at, the vessel's sides, in which case the cameras will be activated when the respective sensors are activated by anyone or anything on the vessel's side and will then begin to record what is happening on the vessel's sides or in the water round the vessel.

### BRIEF DESCRIPTION OF THE DRAWINGS

A preferred embodiment of the device according to the invention is described below in more detail with reference to the attached schematic drawings, which show only the parts necessary for understanding the invention.

FIG. 1 depicts a vessel in operation, seen from the side in view X-Y.

FIGS. 2a-2b depict part of the vessel with spray device according to FIG. 1 in view Y-Z.

FIG. 2c depicts part of the vessel with spray device according to FIG. 1 in view X-Y.

FIGS. 3a-3b depict part of the vessel with spray device according to FIG. 1 in view Y-Z.

FIG. 3c depicts part of the vessel with spray device according to FIG. 1 in view X-Y.

FIG. 4 depicts part of the vessel's side during hostile boarding in view X-Y.

FIG. 5 depicts part of the vessel's side with sensors during hostile boarding in view X-Y.

FIG. 6 depicts part of the vessel's side with cameras during hostile boarding in view X-Y.

### DETAILED DESCRIPTION OF VARIOUS EMBODIMENTS OF THE INVENTION

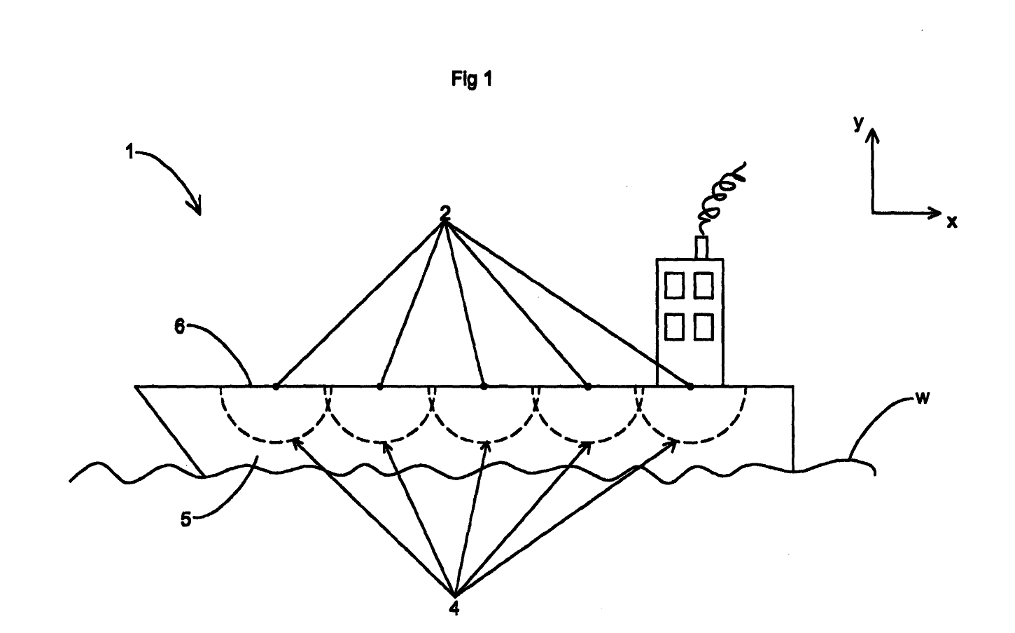

FIG. 1 depicts a vessel 1 in operation in water W. The vessel 1 is provided with a number of spray devices 2 along the vessel's sides 5. FIG. 1 depicts only one side 5. A rail 6 is disposed round the vessel 1 along respective upper parts of the side 5.

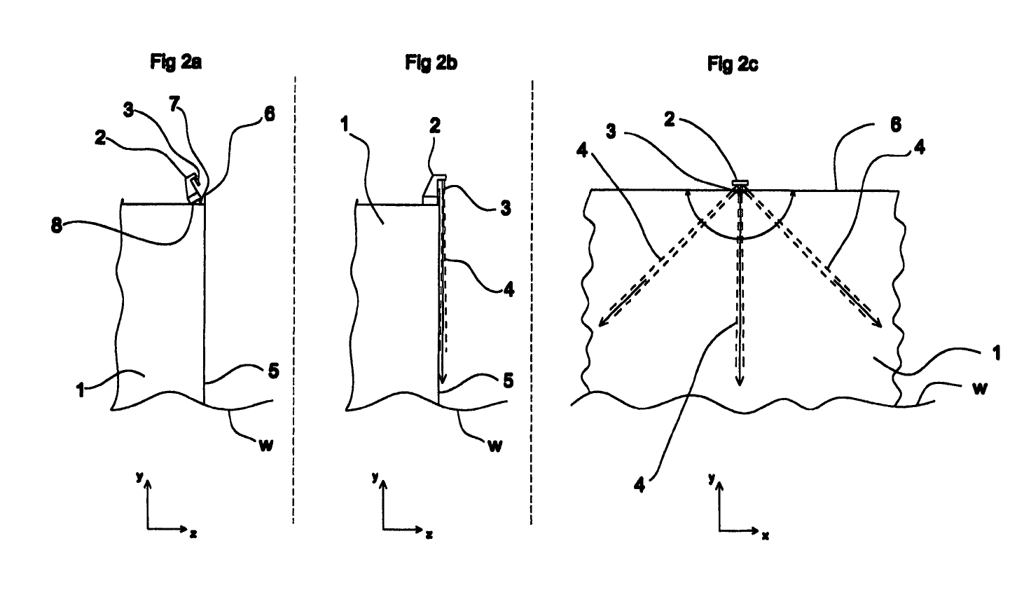

FIGS. 2a-2b depict part of the vessel 1 in a cross-section. FIG. 2a depicts the spray device 2 in a position in which the spray device 2 with nozzle 3 is within the rail 6. The spray device 2 in FIG. 2a is inclined by a regulating device 7, also called pressure cylinder, lifting one end of the spray device, which has its other end connected movably to the vessel 1. According to a variant, the spray device 2 is disposed against and on a frame 8 which makes possible this movement between the spray device 2 and the vessel 1. FIG. 2b depicts the spray device 2 when the regulating device 7 has been minimised so that the spray device 2 with its nozzle 3 is so positioned that the nozzle 3 is outside the rail 6. In this position, the spray device 2 is ready to spray a liquid 4 out from the nozzle 3 upon activation of the system. FIG. 2b shows the liquid 4 being sprayed out from the nozzle 3. The liquid 4 has a direction which in FIG. 2b is parallel with the side 5 of the vessel 1. The liquid 4 is sprayed out from the nozzle 3 at a small distance from the side 5 of the vessel 1. The distance between the sprayed liquid 4 and the side 5 is less than would allow a person to pass between the liquid 4 and the side 5 without being struck and washed away by the liquid 4.

The liquid 4 sprayed from the nozzles 3 may according to an embodiment also has a direction such that it is slightly directed towards the side 5 of the vessel 1. The jet will then strike a target surface on the side 5 of the vessel 1 at a distance from the spray device 2. The angling of the jet will be such that two adjacent spray devices 2 have between them a common target surface on the side 5. This is necessary because after a jet has struck a surface it will have lost some of its pressure and will therefore no longer have the same flushing effect as before it struck the target surface.

FIG. 2c shows how the nozzle 3 pivots about a pivot point on the spray device 2 so that the jet moves to and fro within the angle range of 0-180 degrees and substantially parallel with the side 5 of the vessel 1.

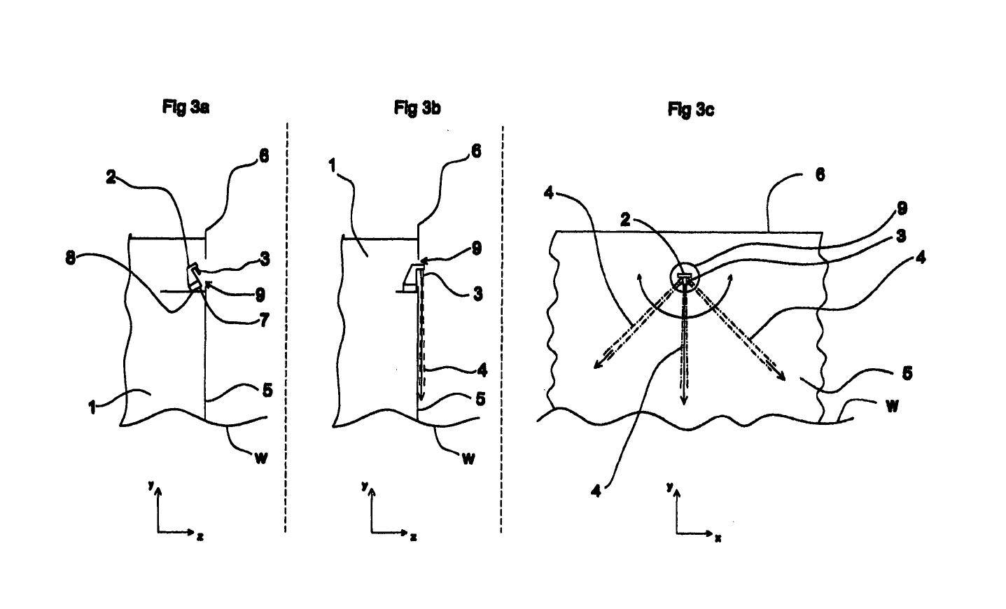

FIGS. 3a-3c depict a spray device 2 according to FIGS. 2a-2c. Instead of being installed on deck, the spray device 2 in FIGS. 3a-3c is installed inside the vessel 1. Upon activation, the spray device 2 is moved out via a hatch or aperture 9 in the side 5 of the vessel 1 to a position for spraying towards the side 5 of the vessel 1. FIG. 3a shows the spray device 2 in its retracted position. A retracted state may be necessary when the vessel 1 passes through narrow passages. FIG. 3b shows the spray device 2 in its deployed position in which it can spray a liquid 4 towards the side 5 of the vessel 1. FIG. 3c shows how the nozzle 3 on the spray device 2 pivots about a pivot point as correspondingly described in relation to FIG. 2c.

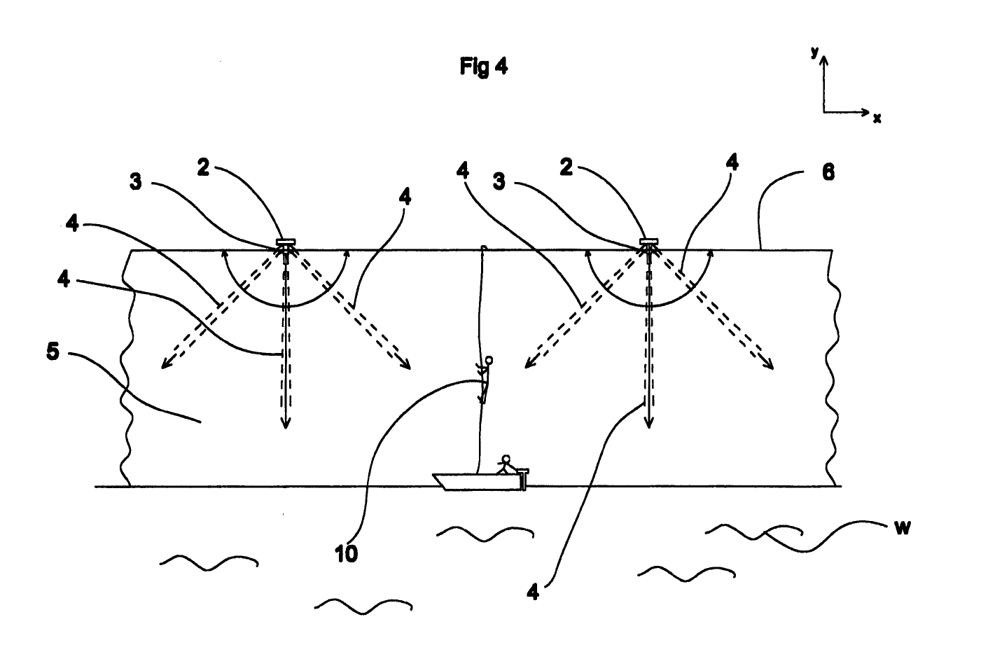

FIG. 4 depicts part of a side 5 of a vessel 1 provided with two adjacent spray devices 2 as described above which are installed at the rail 6 of the vessel 1. A person 10 is depicted climbing up a ropelike element against the side 5 of the vessel 1 with a view to hostile boarding of the vessel 1. The spray devices 2 are then activated by the system to spray liquid 4 along the side 5 of the vessel 1 as above. Upon hostile boarding of the vessel 1, the spray devices 2 spray liquid 4 along the side 5 of the vessel 1. The liquid 4 is sprayed out from respective nozzles 3 at high pressure. This results in the liquid flushing the vessel's side and washing away disturbing elements and persons as above intending hostile boarding of the vessel.

The system of spray devices 2 is so configured that when there is risk of hostile boarding the system can be active so that the sides 5 are continuously sprayed with pressurised liquid 4. A further object of this mode of operation, as well as washing hostile persons and elements away from the side 5 of the vessel 1, may therefore also be to deter. When the vessel 1 passes through regions with heightened risk of hostile boarding, it is therefore possible to cause the spray devices 2 to be switched on and actively spray the sides 5. This will show potential hostile persons that the vessel may be difficult or impossible to board for hostile purposes.

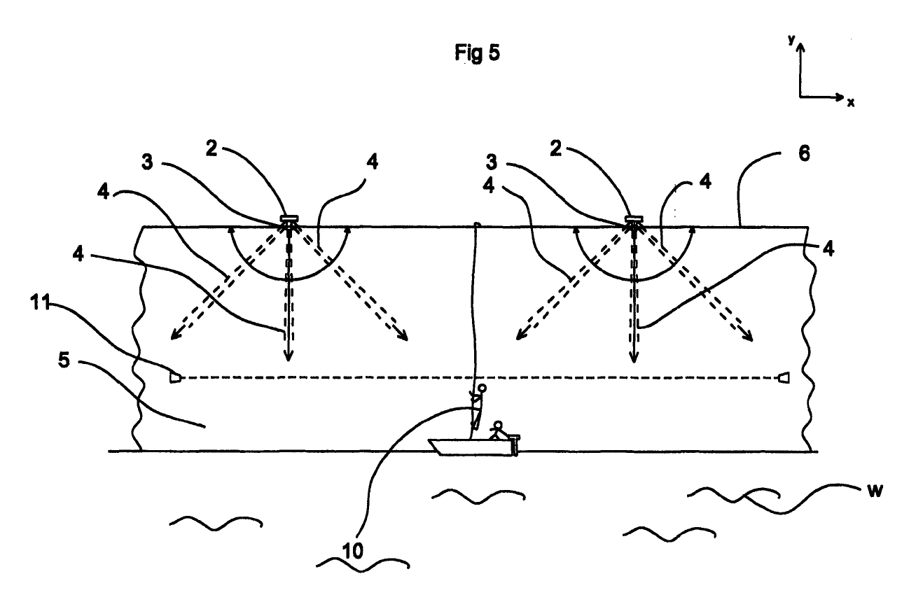

FIG. 5 depicts an embodiment in which the sides 5 are provided sensors 11 configured to detect a person 10 or element with hostile intent moving towards the side 5 of the vessel 1 with a view to a hostile attempt to climb up and board the vessel 1. The sensors 11 may take the form of sensors known to specialists, e.g. infra-red detection, light beam etc. FIG. 5 depicts sensors 11 adapted to activating the system if anyone or anything passes over the broken line along the side 5 of the vessel 1. When the system according to FIG. 5 is activated, the spray devices 2 will begin, as described above, to spray a liquid 4 out at high pressure along the sides 5 of the vessel 1. As the respective nozzles move to and fro parallel with the side 5 of the vessel 1 within the angle range of 0-180 degrees, the sprayed liquid 4 will wash away the hostile person 10 or element on the side 5 of the vessel 1.

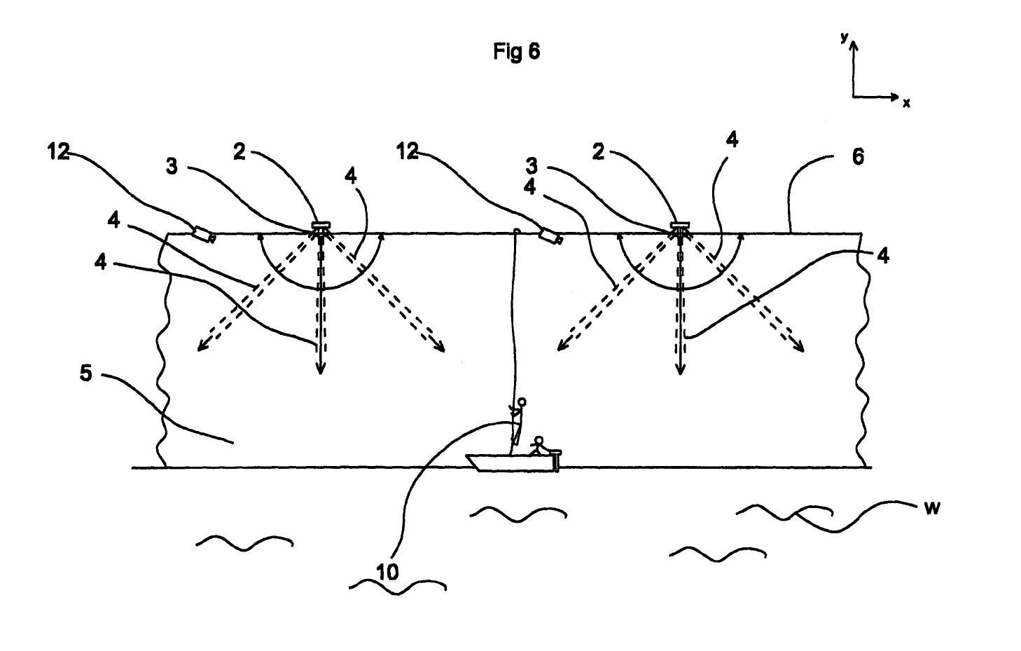

FIG. 6 depicts a further embodiment in which the sides 5 are provided with cameras 12 configured to record any person 10 or element moving towards the side 5 of the vessel 1 with a view to a hostile attempt to climb up and board the vessel 1. The cameras 12 may also be so configured that they record activity in the water W and in the water surface round the vessel 1. This makes it possible at an early stage to activate the system to spray liquid 4 from the spray devices 2 before any hostile persons have yet come close enough to the vessel to be able to commence a hostile boarding. The cameras 12 may be so configured that they send their recorded signals to a unit ashore which has the task of monitoring the images from the cameras 12. When the images show that someone or something is approaching the ship or show something suspicious on, for example, the vessel's side, the person at the monitoring unit will send a signal directly to the system of the vessel 1. The system will then activate the spray devices 2 to spray liquid 4 out in order to wash away the disturbing or hostile elements. Using cameras 12 also makes It possible at an early stage for the monitoring unit call for military or police assistance for the vessel 1 which is subject to an attempt at hostile boarding.

The invention is not limited to the embodiment depicted but may be varied and modified within the scope of the claims set out below, as partly described above.

1. An anti-piracy system to prevent boarding of a vessel (1), which system comprises one or more spray devices (2), each with at least one nozzle (3) which is configured to spray out, upon activation, a liquid (4) supplied to the respective spray devices (2) via a liquid-bearing arrangement, which spray devices (2) are configured to be disposed along at least one side (5) of the vessel (1) and to be so disposed on the vessel (1) that the respective nozzles (3) of the spray devices (2) for spraying of liquid (4) are disposed at a position situated outside the vessel's side (5) or rail (6) so that during spraying of liquid (4) from each nozzle (3) the liquid (4) is sprayed from the nozzle (3) in a direction which substantially follows the side (5) of the vessel (1).

2. A system according to claim 1, in which each spray device is configured to be movable between the position in which the respective nozzles are disposed outside the vessel's side or rail and a position in which the respective nozzles are disposed within the vessel's side or rail.

3. A system according to claim 1, whereby the liquid is sprayed out from the respective nozzles at high pressure, preferably exceeding 3 bar.

4. A system according to claim 1, whereby the liquid-bearing arrangement is configured to convey seawater to the respective spray devices for spraying of seawater out from them.

5. A system according to claim 1, whereby the liquid-bearing arrangement is configured to convey liquid from a liquid tank disposed in the vessel to the respective spray devices for spraying of liquid out from them.

6. A system according to claim 1, such that each spray device is so configured that the nozzle has an oscillating to and fro movement in a plane parallel with the vessel's side so that liquid is sprayed out from the nozzle within an angle range of 0-180 degrees, in which 90 degrees represents a vertical direction from the nozzle towards the surface of the water in which the vessel floats.

7. A system according to claim 1, whereby each spray device is disposed on a respective frame with a regulating device, preferably a pressure cylinder, which is configured to move the respective spray device with the nozzle from the one position to the other.

8. A system according to claim 1, whereby each nozzle disposed at a position outside the vessel's side is caused to pass over the vessel's rail to that position from the position within the vessel's side.

9. A system according to claim 1, whereby each nozzle disposed at a position outside the vessel's side is caused to pass out through an aperture in the side to that position from the position within the vessel's side.

10. A system according to claim 8, whereby the liquid in the liquid-bearing arrangement has, upon activation of the respective spray devices, a pressure which causes the respective spray devices and nozzles to move from a position within the vessel's side to the position with the nozzle outside the vessel's side.

11. A system according to claim 8, whereby each nozzle can be moved manually from the position within the vessel's side to the position outside the vessel's side.

12. A system according to claim 1, whereby the system is configured to be activated by a control unit which controls the respective spray devices and the position of their nozzles.

13. A system according to claim 12, whereby the control unit is remote-controlled.

14. A system according to claim 1, whereby the system is configured to be activated from a navigating bridge of the vessel.
